(19) United States
(12) Patent Application Publication
(10) Pub. No.: US 2026/0231315 A1
(43) Pub. Date: Aug. 6, 2026

(54) LAYERED TARGET FOR NEUTRON GENERATOR

(71) Applicant: Halliburton Energy Services, Inc., Houston, TX (US)

(72) Inventors: Jeffrey James Crawford, Houston, TX (US); Christopher Michael Jones, Houston, TX (US)

(73) Assignee: Halliburton Energy Services, Inc., Houston, TX (US)

(21) Appl. No.: 19/042,531

(22) Filed: Jan. 31, 2025

(51) Int. Cl. H05H 6/00; G01V 5/10

(52) U.S. Cl. CPC H05H 6/00; G01V 5/10

(57) ABSTRACT

A method may comprise disposing a target rod in an insulating tube, wherein a first end of the target rod is in at least partial contact with the insulating tube, and disposing a target material geometry on a second end of the target rod, wherein the second end of the target rod is opposite the first end, and wherein the target material geometry comprises a target film and a barrier material.

### BACKGROUND

Wellbores drilled into subterranean formations may enable recovery of desirable fluids (e.g., hydrocarbons) using a number of different techniques. During drilling operations, or production operations, slickline operations, or wireline operations, measurements may be taken to determine the presence of fluid such as oil, water, gas, or rock and/or the like, or rock fluid properties therein. One such device that may be utilized for these measurements may be a pulsed neutron tool. The pulsed neutron tool may comprise a pulsed neutron generator (PNG) that may operate and function to transmit neutrons into a borehole and or formation for logging measurements such as but not limited to logging while drilling (LWD), wireline logging and production logging measurements.

Generally, a PNG may comprise a compact device capable of induced fusion reactions such as those including deuterium and tritium such as a deuterium/tritium (D/T) neutron generator or a deuterium/deuterium (D/D) pulsed neutron reactor, which may be widely used in a downhole nuclear logging tool for oil and/or gas well measurements, in an environment of elevated temperatures. Although multiple other induced fusion reactions are known, current downhole technology does not make use of them. A D/T or D/D neutron generator may comprise a sealed tube as vacuum housing, a gas reservoir for storing deuterium or tritium gas, an ion source for generating ions which are accelerated by a high voltage (HV) system, and a target which also contains the deuterium or tritium gas for facilitating the respective fusion reactions in the presence of bombardment of associated ions to generate neutrons.

Presently, many neutron generating tubes utilize hot-cathode ion source technology, where a dispenser (hot cathode) is introduced to emit electrons for a direct ionization of gas molecules to produce the D/T atomic and molecular ions. Given a 50 mA (Iₑ) electron emission, a relatively low gas pressure of a few mTorr, a 100 μA (Iᵢₒₙ) ion beam may be routinely extracted either in a CW (continuous wave) or in a pulsed mode and accelerated to bombard a target (a metal film also containing D/T molecules) which is powered at HV such as 100 kV. This may give a neutron yield of about 3×10⁸ n/sec with a lifetime of roughly 1000 hours as is the state of the art for downhole PNGs.

However, there are multiple challenges in constructing a neutron generating tube and/or target assembly. For example, the tubes are challenging and expensive to produce, due to the material requirements, the health and safety concerns, and the labor involved. Furthermore, in the case where tritium gas is loaded into the tube, once a tube is sealed and run, it cannot be refurbished since the tritium is radioactive. This motivates innovation to increase tube lifetime in order to mitigate cost, extend repair and maintenance cycles, to reduce the burden on manufacturing, and ensure reliability during extended drilling operations. Non-oil and gas operations include transportation and security and medical and military operations. Such motivated improvement to PNG lifetime may may also benefit those applications as well.

### BRIEF DESCRIPTION OF THE DRAWINGS

These drawings illustrate certain aspects of some examples of the present disclosure and should not be used to limit or define the disclosure.

FIG. 1 illustrates a downhole tool in a wireline configuration, in accordance with examples of the present disclosure.

FIG. 2 is a diagram of illustrative embodiments of a pulsed-neutron logging tool.

FIG. 3A-3B are diagrams of alternative embodiments of a pulsed-neutron logging tool.

FIG. 4 illustrates the energy of a neutron as it interacts in the present disclosure.

FIG. 5 illustrates an example of a neutron generating tube.

FIG. 6 illustrates an example of the neutron generating tube with a hot cathode ion source.

FIGS. 7A and 7B illustrate possible arrangements of target film and diffusion barrier material.

### DETAILED DESCRIPTION

The present disclosure generally relates to systems and methods for forming at least a part of a neutron generating tube, specifically a target assembly, which may be utilized as a neutron source in a pulsed neutron generator. The description will follow a D/T design, however, may be applied to a D/D design or other gas/target based designs not currently commercial. As discussed below, the primary component that controls the lifetime of a neutron generating tube is a target film of material deposited onto a target rod. The target thin film may comprise of a material that readily forms metal hydrides with deuterium and tritium (chemically hydrogen), holding them in place to facilitate the DD, DT, or TT collisions. The remaining lifetime of the neutron generating tube is determined by the thickness of the material of the target film. Therefore, this leads to the conclusion that the material of the target film should be as a large a thickness as possible. However, there is a point of diminishing returns, where the deuterium or tritium gas may diffuse away from the surface of the target film, leading to a reduction in neutron yield. This limits the thickness of material that can be applied, limiting the maximum lifetime of the neutron generating tube.

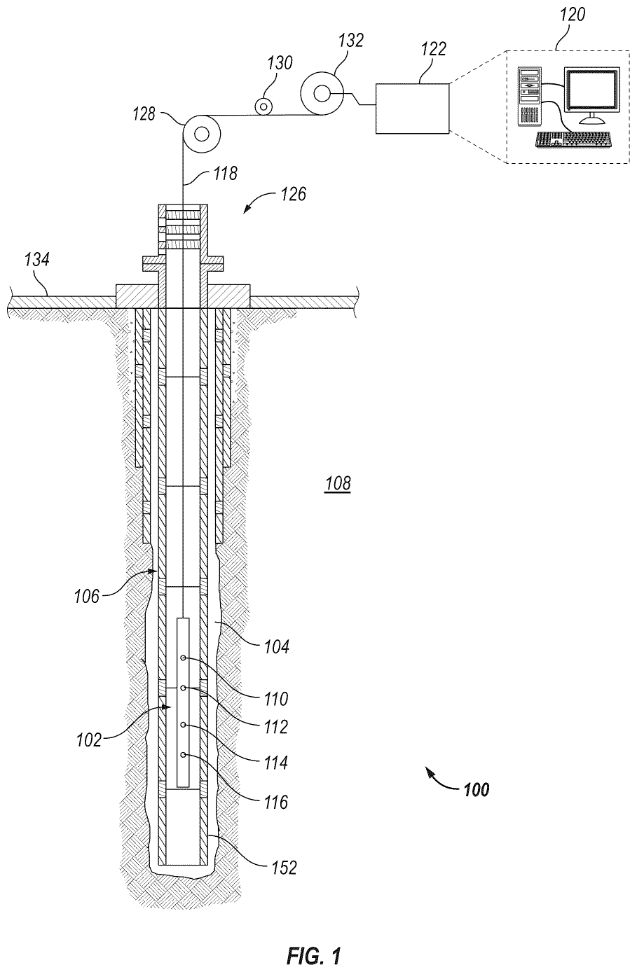

FIG. 1 illustrates logging/measuring operation 100, as disclosed herein, utilizing a pulsed-neutron logging tool 102. FIG. 1 illustrates a cross-section of borehole 104 with a pulsed-neutron logging tool 102 traveling through casing string 106. Borehole 104 may traverse through formation 108 as a vertical well and/or a horizontal well. Pulsed-neutron logging tool 102 contains a neutron generator 110, a first neutron detector 112, a second neutron detector 114, and a gamma ray detector 116. Pulsed-neutron logging tool 102 is suspended by a conveyance 118, which communicates power from a logging facility 120 to pulsed-neutron logging tool 102 and communicates telemetry from pulsed-neutron logging tool 102 to information handling system 122. In examples, pulsed-neutron logging tool 102 may be operatively coupled to a conveyance 118 (e.g., wireline, slickline, coiled tubing, pipe, downhole tractor, and/or the like) which may provide mechanical suspension, as well as electrical connectivity, for pulsed-neutron logging tool 102. Conveyance 118 and pulsed-neutron logging tool 102 may extend within casing string 106 to a depth within borehole 104. Conveyance 118, which may include one or more electrical conductors, may exit wellhead 126, may pass around pulley 128, may engage odometer 130, and may be reeled onto winch 132, which may be employed to raise and lower the tool assembly in borehole 104. Wellhead 126 allows for entry into borehole 104 and placement of pulsed-neutron logging tool 102 into pipe string 152. The position of pulsed-neutron logging tool 102 may be monitored in a number of ways, including an inertial tracker in pulsed-neutron logging tool 102 and a paid-out conveyance length monitor in logging facility 120.

Multiple such measurements may be desirable to enable the system to compensate for varying cable tension and cable stretch due to other factors. Information handling system 122 in logging facility 120 collects telemetry and position measurements and provides position-dependent logs of measurements from pulsed-neutron logging tool 102 and values that may be derived therefrom. Such measurements include Sigma (Macroscopic Thermal Capture Cross Section) as related to the ability of the formation to capture thermal neutrons, which is sensitive to formation water salinity and saturation, elemental concentrations, neutron porosity and formation fluid saturations. One of the primary measurements in pulsed neutron logging is the macroscopic thermal capture cross-section, or sigma. This parameter represents the ability of a formation to absorb thermal neutrons and is particularly sensitive to the presence of chlorine ions, making it a reliable indicator of formation water salinity. By tracking sigma over time, changes in water and hydrocarbon saturation can be monitored, aiding in production optimization and reservoir management. Another critical measurement is elemental concentration, derived from gamma-ray spectroscopy. When neutrons interact with formation elements, they emit gamma rays with specific energy signatures that correspond to elements like carbon, oxygen, chlorine, silicon, calcium, and sulfur. By analyzing these spectral peaks, the tool provides insights into the elemental composition of the formation, which can be used to infer mineralogy and distinguish between reservoir fluids, such as oil and water. Neutron porosity is another valuable output of pulsed neutron logging. It is determined by analyzing the rate at which high-energy neutrons slow down to thermal energies and are captured. This measurement is particularly sensitive to the hydrogen content in the formation, providing an indirect estimate of porosity. Combined with other data, neutron porosity helps differentiate between rock and fluid properties, especially in cased-hole environments. Formation fluid saturation can be assessed by observing changes in neutron capture cross-sections or through spectral analysis of specific elements. For example, the relative proportions of carbon and oxygen can indicate hydrocarbon content, while the presence of chlorine suggests saline water. These measurements are crucial for understanding the distribution and type of fluids in the reservoir, enabling better decision-making for production and recovery strategies.

Pulsed-neutron logging tool 102 generally includes multiple instruments for measuring a variety of downhole parameters. Wheels, bow springs, fins, pads, or other centralizing mechanisms may be employed to keep pulsed-neutron logging tool 102 near the borehole axis during measurement operations. During measurement operations, generally, measurements may be performed as pulsed-neutron logging tool 102 is drawn up hole at a constant rate. The parameters and instruments may vary depending on the needs of the measurement operation.

Pulsed-neutron logging tool 102 operates by generating pulses of high energy neutrons that radiate from neutron generator 110 into the surrounding environment including borehole 104 and formation 108. The highly energetic neutrons entering the surrounding environment interact with atomic nuclei, inducing gamma ray radiation. Induced gamma rays and neutrons may be recorded by first neutron detector 112, second neutron detector 114, and/or gamma ray detector 116. The scattered neutrons and gamma ray spectrum may yield accurate knowledge of borehole and formation. Accurate knowledge of the borehole and formation identifies oil and gas in the formation as well as determining the flow in production wells. In similar fashion the induced gamma rays and neutrons may be recorded by multiple detectors located at varying distances and azimuths from the source.

Measurements taken by pulsed-neutron logging tool 102 may be gathered and/or processed by information handling system 122. For example, signals recorded by pulsed-neutron logging tool 102 may be sent to information handling system 122 where they may be stored on memory and then processed. The processing may be performed real-time during data acquisition or after recovery of pulsed-neutron logging tool 102. Processing may alternatively occur downhole on an information handling system disposed on pulsed-neutron logging tool 102 or may occur both downhole and at surface 134. In some examples, signals recorded by pulsed-neutron logging tool 102 may be conducted to information handling system 122 by way of conveyance 118. Information handling system 122 may process the signals, and the information contained therein may be displayed for an operator to observe and store for future processing and reference. Information handling system 122 may also contain an apparatus for supplying control signals and power to pulsed-neutron logging tool 102.

In logging systems, such as, for example, logging systems utilizing the pulsed-neutron logging tool 102, a digital telemetry system may be employed, wherein an electrical circuit may be used to both supply power to pulsed-neutron logging tool 102 and to transfer data between information handling system 122 and pulsed-neutron logging tool 102. A DC voltage may be provided to pulsed-neutron logging tool 102 by a power supply located above ground level, and data may be coupled to the DC power conductor by a baseband current pulse system. Alternatively, pulsed-neutron logging tool 102 may be powered by batteries located within the downhole tool assembly, and/or the data provided by pulsed-neutron logging tool 102 may be stored within the downhole tool assembly, rather than transmitted to the surface 134 during logging.

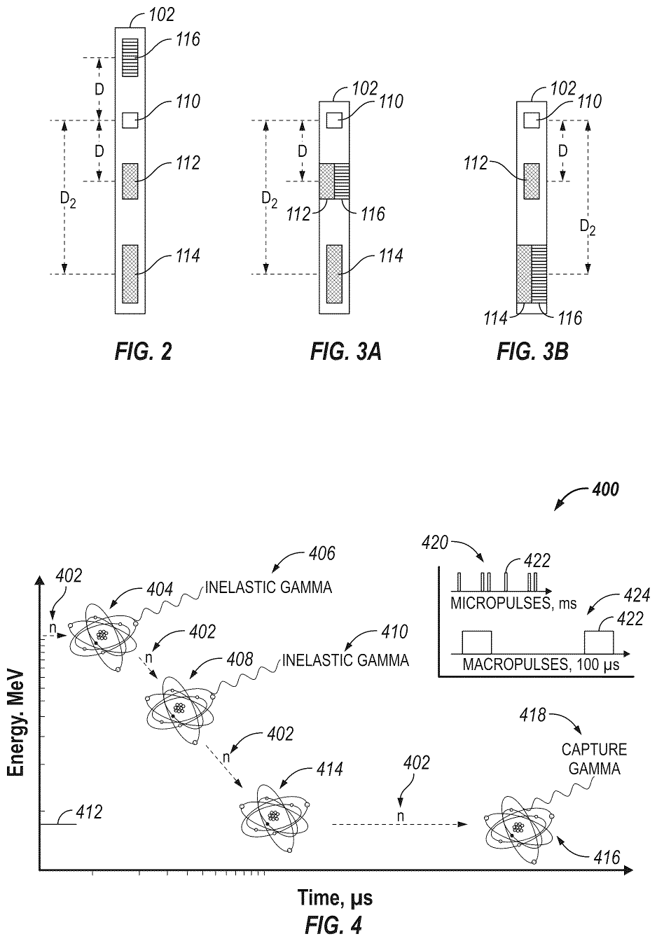

FIG. 2 shows a first illustrative setup of pulsed-neutron logging tool 102 having a pulsed neutron generator 110 that is positioned equidistant from a gamma ray detector 116 and a first neutron detector 112. In examples, pulsed neutron generator 110 may be replaced with a continuous neutron source such as Americium—Beryllium (Am—Be) chemical source. Pulsed-neutron logging tool 102 may also include a second neutron detector 114. The two neutron detectors 112 and 114 may be, respectively, termed the “near” and “far” neutron detectors. “Near” being the closest neutron detector to pulsed neutron generator 110 and “far” being the furthest neutron detector from pulsed neutron generator 110. Neutron detectors 112 and 114 may be designed to count thermal (around about 0.025 eV) and/or epithermal (between about 0.1 eV and 100 eV) neutrons. Suitable neutron detectors include Helium-3 (He-3) filled with proportional counters, though other neutron counters may also be used. In examples, each neutron detector 112 and/or 114 may be implemented as a bank of individual detection devices. General, neutron porosity tool measurement techniques, the ratio of far-to-near neutron detector counts is indicative of formation porosity.

With continued reference to FIG. 2 gamma ray detector 116 may be implemented as a scintillation crystal coupled to a photomultiplier tube. As with neutron detectors 112 and/or 114, gamma ray detector 116 may be implemented as a bank of individual detection devices whose results are aggregated. In FIG. 2, gamma ray detector 116 is “co-distant” with the near neutron detector 112, i.e., it is positioned at the same distance D from neutron generator 110 as near neutron detector 112. As illustrated in FIG. 2, gamma ray detector 116 and first neutron detector 112 may be located in opposite directions from neutron generator 110.

FIGS. 3A and 3B illustrate alternative embodiments of pulsed-neutron logging tool 102. FIG. 3A shows an alternative example in which pulsed-neutron logging tool 102 has a gamma ray detector 116 and a near neutron detector 112 co-located, i.e., located side-by-side at the same distance D from the neutron generator 110. FIG. 3B shows yet another alternative example in which pulsed-neutron logging tool 102 has a gamma ray detector 116 and a far neutron detector 114 co-located at a distance D₂ from neutron generator 110.

Multiple neutron detectors 112, 114 of pulsed-neutron logging tool 102, enable pulsed-neutron logging tool 102 to measure formation porosity using any of the existing multiple-spacing techniques. In addition, the presence of gamma ray detector 116 having a common distance from neutron generator 110 with one of the neutron detectors 112 or 114, enables the measurement of elemental gamma ray spectroscopy, discussed below.

During measurement operations, neutrons emitted from neutron source or pulsed neutron generator 110 undergo neutron scattering and/or nuclear absorption when interacting with matter. Scattering may either be elastic (n, n) or inelastic (n, n′). In an elastic interaction a fraction of the neutrons kinetic energy is transferred to the nucleus. An inelastic interaction is similar, except the nucleus undergoes an internal rearrangement. Additionally, neutrons may also undergo an absorption interaction. During interactions, the elastic cross section is nearly constant, whereas the inelastic scattering cross section and absorption cross sections are proportional to the reciprocal of the neutron speed. For example, inelastic scatterings appear for fast neutrons in the MeV energy range, whereas absorptions happen when neutrons slow down in the eV energy range.

FIG. 4 illustrates a graph 400 that depicts different scattering by a neutron 402. As illustrated, neutron 402 may be traveling at a fast speed with high kinetic energy and interacting with nuclei 404, releasing inelastic gamma 406 and lowering the energy state of neutron 402. After the interaction, neutron 402 contains too much energy to be absorbed, thus continuing its path until it interacts with nuclei 408 releasing inelastic gamma 410 and again lowering its energy state again. After the interaction, neutron 402 has kinetic energy close to target energy 412. Thus, when neutron 402 at target energy 412 interacts with nuclei 414 it will be captured. This interaction results in a rearranged nucleus 416 containing previously traveling neutron 402 and an emitted capture gamma 418. Sensing these events with pulsed-neutron logging tool 102 using first neutron detector 112, second neutron detector 114, and/or gamma ray detector 116 may allow for the identification of oil, gas, and/or water in borehole 104 and formation 108 (e.g., referring to FIG. 1).

With continued reference to FIG. 4, the neutron to gamma ray timing information may be utilized during measurement operations in which a pulsing neutron generator is utilized. In a sub-μs time domain, inelastic gamma rays dominate, whereas in a 10-1000 μs time range, gamma rays are captured. Insert 420 on FIG. 4 illustrates an example of neutron pulse 422 train and insert 424 shows the relationship of two adjacent neutron pulses 422 with a given pulse width and timing interval. Pulsing schemes allow isolation of inelastic and absorption gamma rays and then allow elemental determinations of different nuclei in the bore hole, formation, or fluids.

Pulsed-neutron logging tool 102 is a complicated tool assembly that comprises sensitive and delicate parts that must survive the rigors of a downhole environment within borehole 104. A particularly sensitive part of pulsed-neutron logging tool 102 is neutron generator 110 (e.g., referring to FIG. 1). Discussed below are methods and systems that may be utilized to form a robust neutron generator 110 and a sequence to seal a neutron generating tube vacuum within neutron generator 110. Additionally, systems may further comprise a mechanism for damping arcing and to manage the target thermal heating during operation. These systems and methods may increase the neutron generating tube performance and lifetime capability of the neutron generating tube as compared to current technology.

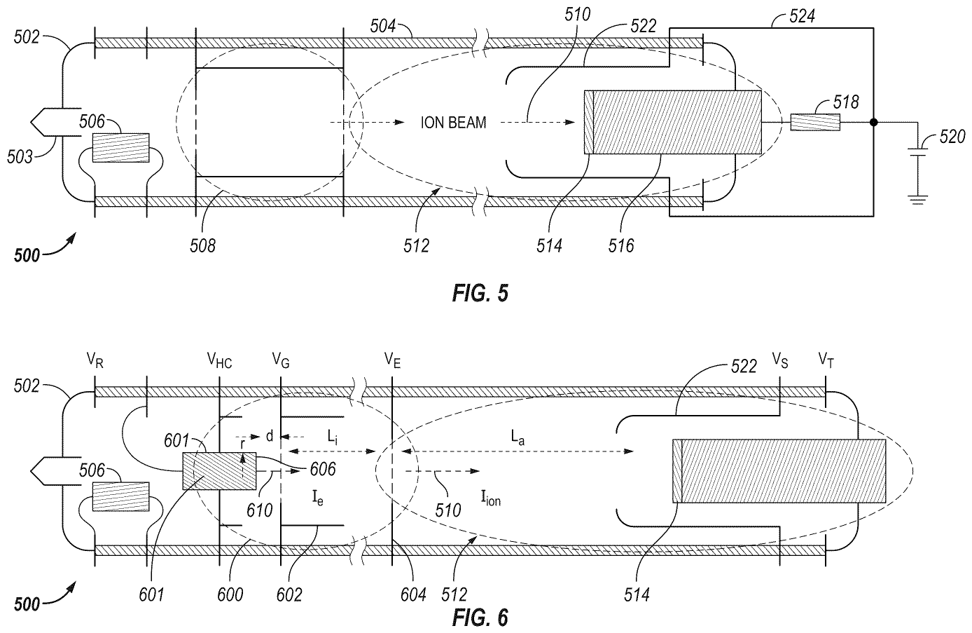

FIG. 5 illustrates a neutron generating tube 500 of neutron generator 110 (e.g., referring to FIG. 1). As illustrated, neutron generating tube 500 may comprise a vacuum housing 502, which may comprise a copper tubing 503 at the end part for vacuum processing. In examples, copper tubing 503 may be later pinched off to seal and create a sealed vacuum within neutron generating tube 500. Vacuum housing 502 may comprise insulating tube 504 for different voltage settings on different parts. In examples, insulating tube 504 may comprise glass and/or ceramic, which are materials that may provide both electrical insulation and enable the formation of a sealed vacuum during a sealing process. For example, insulating tube 504 may comprise one or more nickel-cobalt ferrous alloy washers used as electrodes and one or more ceramic housing rings as insulating spacers in a designed configuration with chosen geometry is brazed together. Within vacuum housing 502, a gas reservoir 506, which is typically porous Titanium or Zirconium metals for absorbing hydrogen gas, may be disposed for storing deuterium and tritium (D/T) gas. Generally, gas reservoir 506 may store a mixture of D₂ and T₂ gas, in a 50-50% ratio. The same D₂ and T₂ gas mixture may also be loaded in target film 514, which faces ion source 508. Target film 514 may be a coating disposed on a target rod 516, utilizing target rod 516 as a backing structure. Target rod 516, for example, may be Copper or other suitable metals which are good for electrical conductivity and thermal dissipation.

Target film 514 may comprise transitional metals, which may form metal hydrides to store hydrogen gas (e.g., D₂ and T₂ gas). Commonly used metals for target film 514 are Scandium, Titanium, Zirconium, or other materials forming hydrides, or chemically or physically absorbing the gas(es) of interest or any combination of these materials in multi-layered form. These transitional metals have been widely studied for applications in neutron generating tubes 500 as both gas reservoir 506 and target film 514. As target film 514 for neutron generating tube 500, the hydrogen to metal atomic ratio inside a saturated metal may be as high as 2:1. Generally, a ratio of 1.8:1 seems to be a practical maximum, while a range of 1.6:1-1.7:1 is common. The ratio may depend at least in part on the ambient temperatures during operation. The ratio degrades at higher temperatures, and may even go down to 0:1, as Hydrogen degases from target film 514. FIG. 12 is a graph that shows the residual Titanium percentage of target film 514 as a function of temperature after heating for one hour at each temperature setting. As seen in the graph, both Zirconium and Titanium start degassing at 200° C. or higher. Scandium may improve the performance of target film 514, which starts to degas at higher temperatures than both Zirconium and Titanium.

Referring back to FIG. 5, during operations, an ion beam 510 from ion source 508 with 100 μA current may be transmitted to bombard target film 514 normally at 100 kV. Thus, there is roughly ten Watts heating power to target film 514 and target rod 516. This may elevate the body temperature of target rod 516 above ambient, often with a ΔT=80-100° C., which may result in degassing of D/T gas from target film 514, such as, Titanium. A decreased D/T gas concentration inside a target film 514 of Titanium may result in a reduced neutron yield for target assembly 512.

As illustrated in FIG. 5, ion source 508 for generating an ion beam 510 may be disposed within vacuum housing 502. During operations, ion source 508 may transmit one or more ion beams 510 to a target assembly 512 disposed within vacuum housing 502. In examples, target rod 516 may act as an electrical connector to HV power supply 520, and a thermal conductor to transfer any excessive heat from target assembly 512 outside of neutron generating tube 500. In this way, D₂ and T₂ molecular ions, generated from ion source 508, may be accelerated to bombard target film 514 loaded with the same gas. During bombardment, the DT, or T-D fusion reactions occur at a given high voltage to generate neutrons. The D-D fusion reaction may have a low cross-section in a typical HV region.

Suppressor 522, which is an added metal electrode, may be utilized to suppress secondary electron emission from target film 514. As illustrated, suppressor 522 may be connected via a corona shield 524 outside vacuum housing 502 to high voltage (HV) power supply 520. Additionally, suppressor 522 may operate and function to accelerate ion beam 510 for bombarding target assembly 512, which may create a D/T fusion reaction to generate neutrons. A corona shield 524 may operate and function to smoothen an electrical field that is generated outside target assembly 512 by neutron generating tube 500. Corona shield 524 may function as the electrical connector between HV power supply 520 and suppressor 522. During an example operation, a resistor 518 that may be 2 MΩ, and an ion beam 510 of 100 μA, may produce an automatic voltage difference of 200 V between suppressor 522 and target film 514, to send back the secondary low-energy electrons. For a given HV power supply 520 of 100 kV, an ion beam 510 of 100 μA current, and a saturated target film 514 (for this example made of Titanium) at a level of 1.8-2.0 D/T atoms per Titanium atom, a neutron yield typically of 3×10⁸ n/sec may be generated. The generated neutrons may then be transmitted from neutron generator 110 as described above.

FIG. 6 illustrates another example of neutron generating tube 500. In this example, neutron generating tube 500 may comprise a hot-cathode ion source 600 that may generate an ion beam 510 and transmit ion beam 510 to target assembly 512. As illustrated, hot-cathode ion source 600 may comprise a hot-cathode 601, a grid electrode 602, and an extractor electrode 604. During operations, hot-cathode ion source 600 does not need a magnetic field to trap ions and electrons to form plasma. Thus, one of the advantages of hot-cathode ion source 600 is that ion beam 510 may be quickly switched on/off by controlling the electron mission from hot-cathode 601 to stop ionization and at the same time by controlling ion beam 510 extraction inside hot-cathode ion source 600. This may allow for fast and sharp pulsing, as illustrated and described in FIG. 4, possible with the rise and fall times in a 200-500 nano second range. During operation, V_{R}, V_{HC}, V_{G}, and V_{E} may be applied as controlling voltages with electrical currents on gas reservoir 506, hot cathode 601, grid electrode 602, and extractor electrode 604. Grid electrode 602 may function as a control for electron emission from surface 606 of hot cathode 601, and a driver for electron beam 610 inside the ion source 600, whereas extractor electrode 604 may function together with grid electrode 602 for extraction of ion beam 510. As illustrated, r, d, and Lᵢ are radius of surface 606 of hot cathode 601, the distance between surface 606 of hot cathode 601 to the grid on the grid electrode 602, and the length of the ion source volume, respectively. In examples, Lᵢ may be about 1.0 cm. Iₑ and Iᵢₒₙ represent the electron beam 610 and extracted ion beam 510 currents. In examples, Iₑ may be about 30-50 mA. Since the hydrogen molecular ionization cross section peaks between 50-200 eV, relatively low control voltages (<250 v) for V_{G}, and V_{E} may be utilized to operate hot-cathode ion source 600. Lₐ is the distance from extractor electrode 604 to the target film 514 in the acceleration column, and V_{S}, V_{T} are ion acceleration voltages applied to suppressor 522 and target film 514. Given a gas pressure inside vacuum housing 502 of 1-5 mTorr and 50 mA electron current in a 1.0 cm ion source geometry, a 150 μA ion current may be extracted routinely assuming a 100% efficiency for ion extraction. Both transparencies of grid electrode 602 and extractor electrode 604 may reduce the final ion current. However, the gas pressure is a parameter which may be adjusted higher to compensate for any ion losses.

During operations, gas reservoir 506 may be heated to generate a few mTorr gas pressure. Hot cathode 601 (with a 4-5 mm diameter, and d in a range of 1-2 mm) may be heated so that plenty electron charges hover near its surface space 606. By applying a grid voltage V_{G} in a range of 200-250 V, an electron beam 610 with a current of 30-50 mA may transmit inside hot cathode ion source 600 with a pass length of 1.0 cm. Through ionization processes, ions with a beam current of more than 100 μA in ion beam 510 may be extracted with the extractor at V_{E} ranging from 0 to −50 V. Furthermore, a pulsed operation, with a typically 20% duty factor, may be achieved by turning on and off V_{G}, and V_{E} in sync, with a 200-500 ns rise and fall times.

Generally, V_{S} and V_{T} are ion acceleration voltages applied to suppressor 522 and target film 514 which may be typically around 100 kV. Lₐ the distance from extractor electrode 604 to target film 514 in the acceleration column, ranges from 2-4 cm, depending on ion beam optics. Target film 514, typically Titanium, may have a diameter of 6-10 mm, with a thickness of 3-5 μm, which may be saturated with D/T mixed gas. As stated, for a given HV power supply 520 of 100 kV, an ion beam 510 of 100 μA current, and a saturated target film 514 of Titanium at a level of 1.8-2.0 D/T atoms per Titanium atom, a neutron yield typically of 3×10⁸ n/sec may be generated with 1000 hours of neutron generating tube 500 lifetime expectancy.

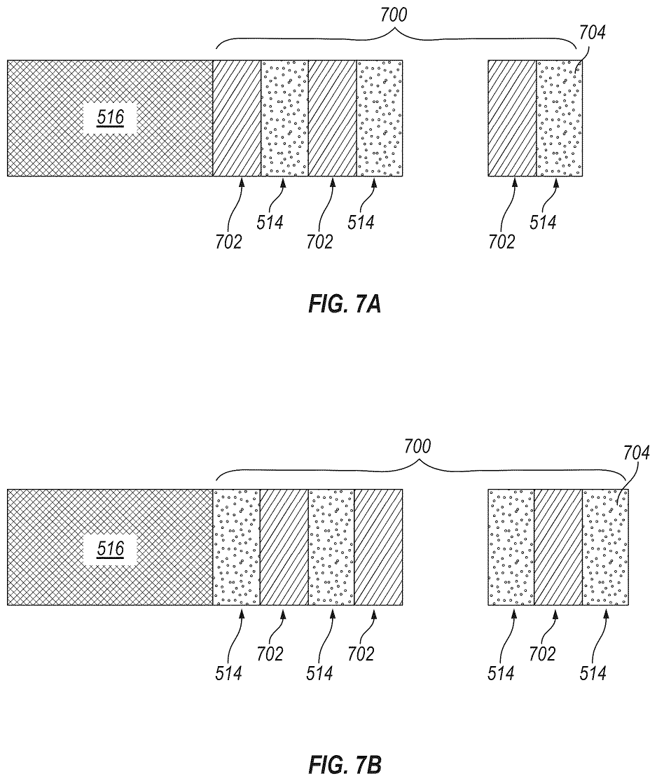

Methods and systems are discussed below address the construction of target rod 516 and target film 514. Referring to FIGS. 7A and 7B, generally, target film 514 may be applied to target rod 516 by depositing a single layer of material, such as titanium or zirconium, or plurality of layers onto target rod 516, which is a highly conductive material such as copper. In cases where target materials are used that do not adhere well to target rod 516, a buffer layer of material may be used. In examples, buffer layer may have a depth of a few nanometers to a few micrometers. As illustrated in FIGS. 7A and 7B, deposition of a target material geometry 700 may comprise alternating layers of material are deposited onto the target rod 516. The alternating layers may comprise of a diffusion barrier material 702 and a target film 514. Diffusion barrier material 702 which, as a non-limiting example, may include titanium oxide or aluminum oxide. The target material geometry 700 may comprise up to seven successive alternating layers of target film 514 and diffusion barrier material 702. Target film 514 may be a material, which as a non-limiting example, that may include titanium, scandium, or zirconium, may be of thickness from less than a nanometer to thickness to less than a few micrometers of the diffusion barrier, interlaced with the target deposition material for one to one hundred or more interlacing layers (one interlacing layer being either contained within or at the top or the bottom of target film 514).

Diffusion barrier materials may be adjusted in thickness and or material to optimize diffusion properties. Such diffusion properties may include resistance to hydrogen migration within the hydride forming material. However, other diffusion properties may also be considered when selecting a diffusion barrier material. Such properties may be chemical compatibility with the hydride forming material, thermal transport properties in order to allow heat to flow freely between the layers (i.e., diffusion barrier material 702 and a target film 514), thermal stress reduction to prevent delamination or cracking, and/or adhesion. The aforementioned buffer layers may also be used to assist the adhesion of the diffusion reduction layers to the hydride forming layers. Titanium dioxide and/or aluminum oxide are good diffusion reduction layers with good thermal conductivity, good thermal matching to titanium, and good adhesion to titanium. These materials may also be strong diffusion barriers to that of hydrogen such that very thin nanometer scale layering may be used (i.e., single nanometers to tens of nanometers). This may allow a larger amount of target film 514 to be deposited while maintaining the proper surface density of deuterium and tritium to preserve neutron yield. This results in a longer life of neutron generating tube 500 (e.g., referring to FIG. 5).

The choice of the buffer layer material follows various considerations. Chromium (Cr) forms excellent bonds with both metals (like copper) and hydride-forming materials. It also provides a good thermal expansion match and prevents diffusion between layers. Nickel (Ni) is a good intermediate layer due to its excellent adhesion properties and chemical stability. It is also resistant to oxidation and provides good thermal conductivity. Tantalum (Ta) is chemically compatible with hydride-forming metals and provides excellent adhesion to copper. It also has a high melting point and good thermal stability. Molybdenum (Mo) has a thermal expansion coefficient that is compatible with both copper and hydride-forming materials. It is also thermally and chemically stable. Titanium oxide (TiO2) and Titanium Nitride (TiN) is a robust adhesion layer with good thermal and chemical stability. It also acts as a diffusion barrier, preventing intermixing between the target material and the copper heat sink. Aluminum Nitride (AlN) and aluminum oxide (Al2O3) provide high thermal conductivity and good adhesion to both metals and hydrides. It is particularly useful if thermal management is a significant concern. These materials may act as adhesion promoters or insulating layers, particularly in systems where electrical isolation is also required. Silicon may also form hydrides, providing some compatibility. In general good buffer materials match the coefficients of thermal expansion (CTEs) between layers (diffusion barrier material 702 and a target film 514) to reduce stress and delamination during thermal cycling. Chemical compatibility such that the buffer layer should not react adversely with the target material or heat sink. The thickness of the buffer layer needs to balance adhesion improvement with thermal conductivity and mechanical integrity.

During construction of target material geometry 700, layering and thickness may be designed based at least in part on the material properties of diffusion barrier material 702 and a target film 514, the geometric constraints of neutron generating tube 500 configurations, and the total activity (amount) of the tritium gas. In examples, target film 514 (hydriding target film) may be deposited with a thickness of a few micrometers to a few tens of micrometers (1 to 50) dependent on the application. The depth, or amount, of target film 514 applied may be controlled by a thin layer chemical or physical layer deposition (i.e., CVD or PVD). During construction, target film 514 may be disposed as an outermost layer 704 of target material geometry 700. However, in other examples, outermost layer 704 may be diffusion barrier material 702. When depositing diffusion barrier material 702 to target film 514 the outermost thickness may be thicker than the internal layers. The thickness may prevent hydrogen escape from target film 514 but must not be so thick as to prevent ion penetration. The thickness allowance may be varied by PNG design including the rate and force of ion bombardment in this respect. However, a few nanometers to a few micrometers are generally appropriate.

Diffusion barrier material 702 may also act as a hydriding material, such as titanium with respect to other hydriding materials, which would further improve the lifetime of diffusion barrier material 702. Diffusion barrier material 702 (hydriding target film) may be deposited at a depth of a few nanometers. Thickness and or frequency of the layering may be adjusted with respect to the bulk such that the thickness of the layering increases toward the target surface, or frequency increases toward the surface of the material. Thinning and lower frequencies toward the surface may be used to adjust other PNG properties such as increased output vs increased lifetime, the two parameters being inverse to each other. The depth, or amount, of diffusion barrier material 702 applied may be controlled by the CVD or PVD process that is used to deposit the bulk material.

When depositing target film 514 to diffusion barrier material 702 the density of the film, uniformity of the film, structure of the film, lamination pattern including thickness and distributions may be adjusted by processes known to those skilled in the art in order to achieve diffusion flux that is favorable with respect to operation. In this example, target rod 516 may be moved or rotated during operations or between operations in order to access favorable zones on target rod 516 with different regions of target rod 516 having different thin film properties as discussed. Such conditions to optimize operation may include wear of target rod 516, flux of the hydrogen, ion flux of bombardment to target rod 516, energy of the ion flux bombarding target rod 516, and the like. The rotation or movement mechanism may be internal to target rod 516 or external to target rod 516. In some embodiments, the zone rotated to or moved to may be absent of diffusion material as a favorable zone. The rotation or movement of target rod 516 may be accomplished by an internal incrementing motor, or externally through a coupling mechanism such as a mechanical or magnetic coupling mechanism. Target rod 516 may be locked in place after movement or moved continuously in adjustment to deposit diffusion barrier material 702 and a target film 514 in successive layers as needed on target rod 516.

It should be noted that the depth for each target film 514 layer to each diffusion barrier material 702 layer may be at a maximized ratio of target material to diffusion barrier material is desirable. Utilizing multiple layers such as diffusion barrier material 702 and a target film 514 may improve reliability and reduce repair and maintenance costs of neutron generating tube 500. The hydride reaction may be loaded during each phase of the diffusion layering process such that the largest reservoir of hydride material is at the bottom of the stack and the smallest is at the surface. The copper block may be structured with pathways for replenishing such as small micro or mezzo scale tubing or pores. Such tubing or pores may be mechanically or electrically opened during a replenishing process but closed again during normal use. Use of a shape changing material, electrically or thermally operated may open such tubing or pores during replenishing with the unpowered state closed. Thermal mismatch may also be used to open such tubing or pores during replenishing. Alternatively, a mechanical operation may be used for replenishment.

The preceding description provides various examples of the systems and methods of use disclosed herein which may contain different method steps and alternative combinations of components.
Statement 1: A method may comprise disposing a target rod in an insulating tube, wherein a first end of the target rod is in at least partial contact with the insulating tube, and disposing a target material geometry on a second end of the target rod, wherein the second end of the target rod is opposite the first end, and wherein the target material geometry comprises a target film and a barrier material.
Statement 2: The method of statement 1, wherein a first layer of the target material geometry is the target film and the target film is in contact with the target rod.
Statement 3: The method of statement 2, wherein a buffer layer is disposed between the target film and the target rod.
Statement 4: The method of statement 3, wherein the buffer layer is chromium, nickel, tantalum, molybdenum, titanium oxide, titanium nitride, aluminum nitride, or aluminum oxide.
Statement 5: The method of any previous statements 1 or 2, wherein the target film comprises scandium, titanium, or zirconium.
Statement 6: The method of any previous statements 1, 2, or 5, wherein the barrier material is disposed on the target film.
Statement 7: The method of statement 6, wherein the target material geometry comprises a plurality of layers and each successive layer alternates between the target film and the barrier material.
Statement 8: The method of statement 7, wherein an outermost layer of the target material geometry is the target film.
Statement 9: The method of any previous statements, 1, 2, 5, or 6, wherein a first layer of the target material geometry is the barrier material and the barrier material is in contact with the target rod.
Statement 10: The method of statement 9, wherein a buffer layer is disposed between the first layer and the target rod.
Statement 11: The method of statement 10, wherein the buffer layer is chromium, nickel, tantalum, molybdenum, titanium oxide, titanium nitride, aluminum nitride, or aluminum oxide.
Statement 12: The method of claim 9, wherein the barrier material comprises titanium dioxide or an aluminum oxide.
Statement 13: The method of statement 12, wherein the target film is disposed on the barrier material.
Statement 14: The method of statement 13, wherein the target material geometry comprises a plurality of layers and each successive layer alternates between the target film and the barrier material.
Statement 15: The method of statement 14, wherein an outermost layer of the target material geometry is the barrier material.
Statement 16: A system may comprise a target rod disposed in an insulating tube, wherein a first end of the target rod is in at least partial contact with the insulating tube, and a target material geometry disposed on a second end of the target rod, wherein the second end of the target rod is opposite the first end, and wherein the target material geometry comprises a plurality of successive layers, wherein each layer alternates between a target film and a barrier material.
Statement 17: The system of statement 16, wherein a first layer of the target material geometry is the target film and the target film is in contact with the target rod.
Statement 18: The system of statement 17, wherein a buffer layer is disposed between the target film and the target rod.
Statement 19: The system of statement 18, wherein the buffer layer is chromium, nickel, tantalum, molybdenum, titanium oxide, titanium nitride, aluminum nitride, or aluminum oxide.
Statement 20: The system of any previous statements 17 or 18, wherein the target film comprises Scandium, Titanium, or Zirconium.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a target rod in an insulating tube, wherein a first end of the target rod is in at least partial contact with the insulating tube; and
disposing a target material geometry on a second end of the target rod, wherein the second end of the target rod is opposite the first end, and wherein the target material geometry comprises a target film and a barrier material.

2. The method of claim 1, wherein a first layer of the target material geometry is the target film and the target film is in contact with the target rod.

3. The method of claim 2, wherein a buffer layer is disposed between the target film and the target rod.

4. The method of claim 3, wherein the buffer layer is chromium, nickel, tantalum, molybdenum, titanium oxide, titanium nitride, aluminum nitride, or aluminum oxide.

5. The method of claim 2, wherein the target film comprises scandium, titanium, or zirconium.

6. The method of claim 2, wherein the barrier material is disposed on the target film.

7. The method of claim 6, wherein the target material geometry comprises a plurality of layers and each successive layer alternates between the target film and the barrier material.

8. The method of claim 7, wherein an outermost layer of the target material geometry is the target film.

9. The method of claim 1, wherein a first layer of the target material geometry is the barrier material and the barrier material is in contact with the target rod.

10. The method of claim 9, wherein a buffer layer is disposed between the first layer and the target rod.

11. The method of claim 10, wherein the buffer layer is chromium, nickel, tantalum, molybdenum, titanium oxide, titanium nitride, aluminum nitride, or aluminum oxide.

12. The method of claim 9, wherein the barrier material comprises titanium dioxide or an aluminum oxide.

13. The method of claim 12, wherein the target film is disposed on the barrier material.

14. The method of claim 13, wherein the target material geometry comprises a plurality of layers and each successive layer alternates between the target film and the barrier material.

15. The method of claim 14, wherein an outermost layer of the target material geometry is the barrier material.

16. A system comprising:
a target rod disposed in an insulating tube, wherein a first end of the target rod is in at least partial contact with the insulating tube; and
a target material geometry disposed on a second end of the target rod, wherein the second end of the target rod is opposite the first end, and wherein the target material geometry comprises a plurality of successive layers, wherein each layer alternates between a target film and a barrier material.

17. The system of claim 16, wherein a first layer of the target material geometry is the target film and the target film is in contact with the target rod.

18. The system of claim 17, wherein a buffer layer is disposed between the target film and the target rod.

19. The system of claim 18, wherein the buffer layer is chromium, nickel, tantalum, molybdenum, titanium oxide, titanium nitride, aluminum nitride, or aluminum oxide.

20. The system of claim 17, wherein the target film comprises Scandium, Titanium, or Zirconium.
